(19) United States
(12) Patent Application Publication
(10) Pub. No.: US 2005/0280188 A1
(43) Pub. Date: Dec. 22, 2005

(54) Core block split into common parts

(75) Inventors: Euclide Cecchin, Windsor (CA); Calvin Matte, McGregor (CA)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(73) Assignee: Euclide Cecchin

(21) Appl. No.: 11/106,418

(22) Filed: Apr. 14, 2005

Related U.S. Application Data
(60) Provisional application No. 60/582,012, filed on Jun. 22, 2004.

(51) Int. Cl. B29C 45/42

(52) U.S. Cl. 264/334; 425/556

(57) ABSTRACT

The assembly is characterized by a plurality of ejectors (32) each including a stationary portion (34) immovably mounted on the base (22) by screws and an actuatable portion (36) extending through the mold (20). Each ejector (32) is independently actuatable for ejecting the part (24) from the shaping surface of the mold (20). Both the mold (20) and the ejectors (32) are attached to the base (22) and do not move relative to the base (22) during the molding process and only the mold (20) includes cooling passages (54) whereby molds (20) substituted for one another and the ejectors (32) arranged in different configurations to accommodate the respective molds (20).

### CROSS REFERENCE TO RELATED APPLICATION

This application claims the benefit of provisional application Ser. No. 60/582,012 filed Jun. 22, 2004.

### BACKGROUND OF THE INVENTION

1. Field of the Invention

The invention relates to a mold assembly and method of operating such a mold assembly for an injection molding machine.

2. Description of the Prior Art

In the field of plastic injection molding it is advantageous to reduce the labor and material required to manufacture separate molds for molding parts of differing shapes. Reduction in manufacturing labor and material is often achieved by commonizing components, which allows components to be removed from one assembly and placed on a second assembly without the need of creating a new component, thus decreasing labor and material costs associated with creating a new component. In order to achieve this, several modularized mold assemblies have been developed which include a base for disposition in a molding machine and a mold presenting a shaping surface for forming a part. Typically the mold is attached to the base with a mounting system for mounting the mold on the base to prevent relative movement therebetween during the forming of the part. Such an assembly and method for using the assembly is shown in the U.S. Pat. No. 6,328,552 to Hendrickson et al. This assembly includes a base for use with interchangeable molds to create parts of differing shape. However, the parts are ejected from the mold by an ejection plate which is moveable by an outside source and which includes a plurality of ejector pins which extend through the mold to eject the parts when the ejection plate is moved. In other words, all of the ejection pins are fixed on a movable ejection plate. Such an ejector assembly adds weight and length to the assembly and additional time and labor is required to adapt such an ejector assembly to different molds.

Other assemblies have included an ejection actuator that is located entirely within the base and is removable from the base for reuse in a second base, as illustrated in U.S. Pat. No. 3,645,492 to Edlis. This assembly includes an actuator mounted entirely within the base. However, this assembly also includes an ejector plate to move all of the ejection pins in unison. During ejection, an actuator displaces the ejection plate and the ejector pins extend through the mold to eject part.

### SUMMARY OF THE INVENTION AND ADVANTAGES

The invention is characterized by immovably mounting a plurality of ejectors in a chamber defined by the mold on the base and extending through the mold for actuation independently of one another for ejecting the part from the shaping surface.

The current assemblies or methods do not include independently actuatable ejectors mounted on a base immovable relative to a mold in a chamber defined by the mold, which allows the base and ejectors to be reused with multiple molds by rearranging the ejectors on the base and which decreases the weight and size of the assembly.

Accordingly, the base and ejectors are reusable with a plurality of molds by removing the mold from the base, removing the ejectors from the base, mounting the ejectors on the base in a position to accommodate a second mold, and mounting the second mold on the base.

In addition, the existence of the chamber and the placement of the ejector in the chamber decreases the size and weight of the assembly.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a perspective view of a mold assembly incorporating the subject invention;

FIG. 2 is a cross sectional view taken along line 2-2 of FIG. 1;

FIG. 3 is a cross sectional view taken along line 3-3 of FIG. 2;

FIG. 4 is a perspective and exploded view of the mold assembly of FIG. 1;

FIG. 5 is a plan view of the base of the mold assembly of FIGS. 1 and 4;

### DETAILED DESCRIPTION OF THE PREFERRED EMBODIMENT

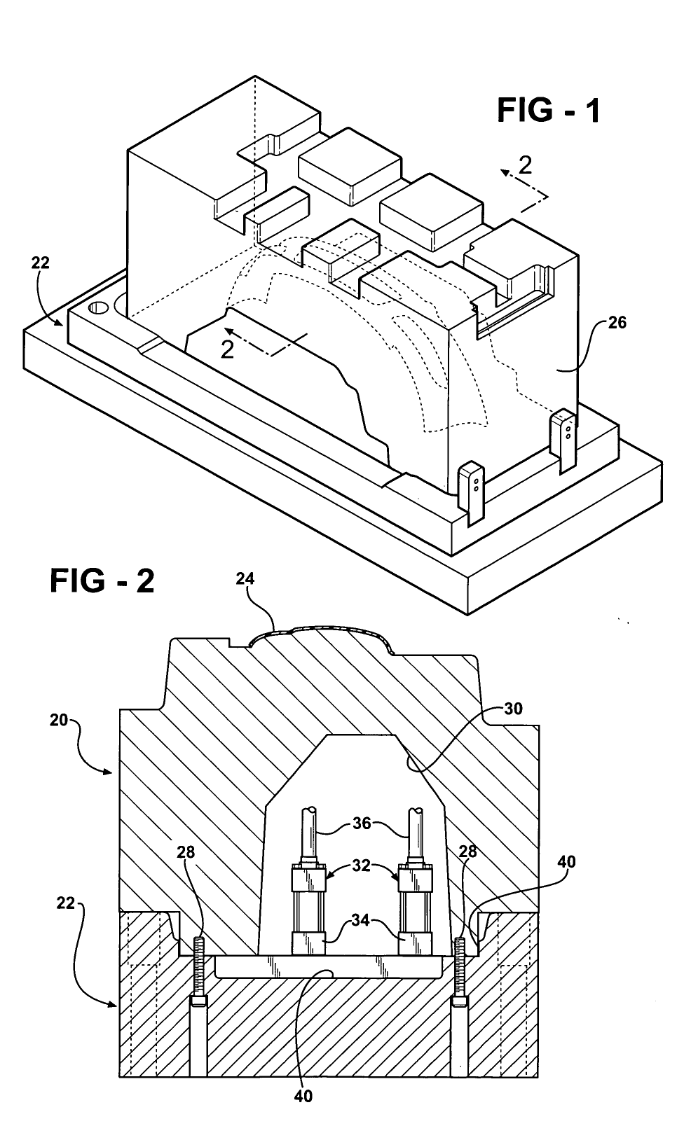

An assembly for an injection molding machine is generally shown in FIGS. 1 and 4. The assembly includes a mold, generally indicated at 20, and a base, generally indicated at 22, for disposition in a molding machine (shown but not numbered in FIG. 1). The molding machine is of the well known type for opening and closing the assembly to sequentially form a plastic part 24 in a cavity. The mold 20 presents a shaping surface in the cavity for forming the part 24. An upper half 26 defines the remaining shaping surface of the cavity which is opened when the machine or press raises the upper half 26 relative to the stationary base 22 supported on a platen in the machine, as shown in FIG. 1.

A plurality of bolts 28 define a mounting system for mounting the mold 20 on the base 22 to prevent relative movement therebetween during the forming of the part 24. The bolts 28 extend through the base 22 and threadedly engage the mold 20 to immovably attach the mold 20 to the base 22.

The assembly is characterized by the mold 20 defining a chamber 30 with the base 22 and by including a plurality of ejectors, each generally indicated at 32, immovably mounted on the base 22 in the chamber 30 and extending through the mold 20 and independently actuatable for ejecting the part 24 from the shaping surface in the cavity. The creation of the chamber 30 results in weight reduction of the mold 20. Also, since the existance of the chamber 30 allows the ejectors 32 to be disposed in the chamber 30 the distance required between the molding machine platens is shortened. The size and weight reduction allows easier movement and mounting of the mold assembly and reduces the required size of the molding machine. Each of the ejectors 32 includes a stationary portion 34 immovably mounted on the base 22 and an actuatable portion 36 extending through the mold 20 and movable relative to the stationary portion 34 and the base 22 for ejecting the part 24 from the shaping surface. Where the actuatable portion 36 extends through the mold 20 the contour of the actuatable portion 36 generally follows the contour of the shaping surface so that the actuatable portion 36 shapes a portion of the part 24. The ejectors 32 include threaded screws 38 defining fastening devices for removably attaching the stationary portion 34 of each ejector 32 to the base 22 independently of one another. The threaded screws 38 extend through the stationary portion 34 of each ejector 32 and into threaded engagement with the base 22.

The base 22 presents a recess 40 presenting a periphery and the mold 20 interfaces with the periphery of the recess 40 in the base 22. The ejectors 32 are disposed in the recess 40. Preferably, the base 22 includes a multiplicity of threaded holes 42 for mounting the ejectors 32 in a variety of configurations, depending upon the particular mold 20 and part 24 being formed. In other words, the shape of the part 24 being formed determines the positions of the various ejectors 32 to eject the part 24 from the mold 20. The ejectors 32 may be electric, hydraulic, pneumatic or mechanical but in any case the ejectors 32 are actuated independently of one another from a controller for actuating each of the ejectors 32 to move the actuatable portion 36 of each ejector 32. This is in contradistinction to the prior art plate or platen supporting a plurality of rods to move the rods in unison to remove the part 24 from a mold 20. Because each ejector 32 includes a stationary portion 34 attached directly to the base 22, a controller, such as a valve or computer, sends an independent actuation signal to each ejector 32. This means, of course, that the respective ejectors 32 may be actuated sequentially to sequentially remove areas of the part 24 from the mold 20.

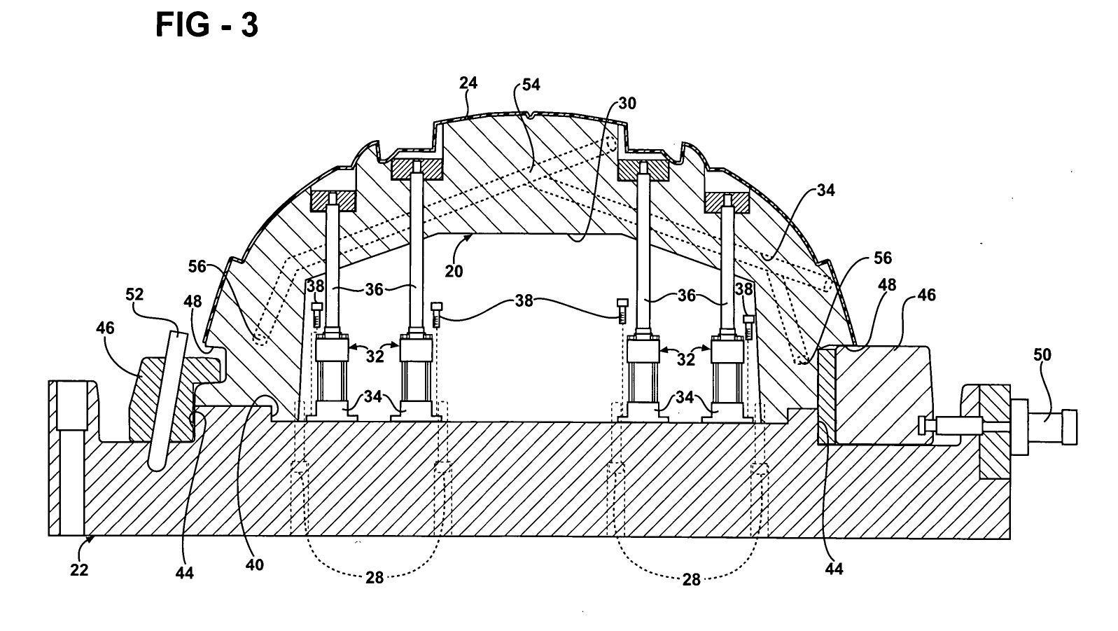

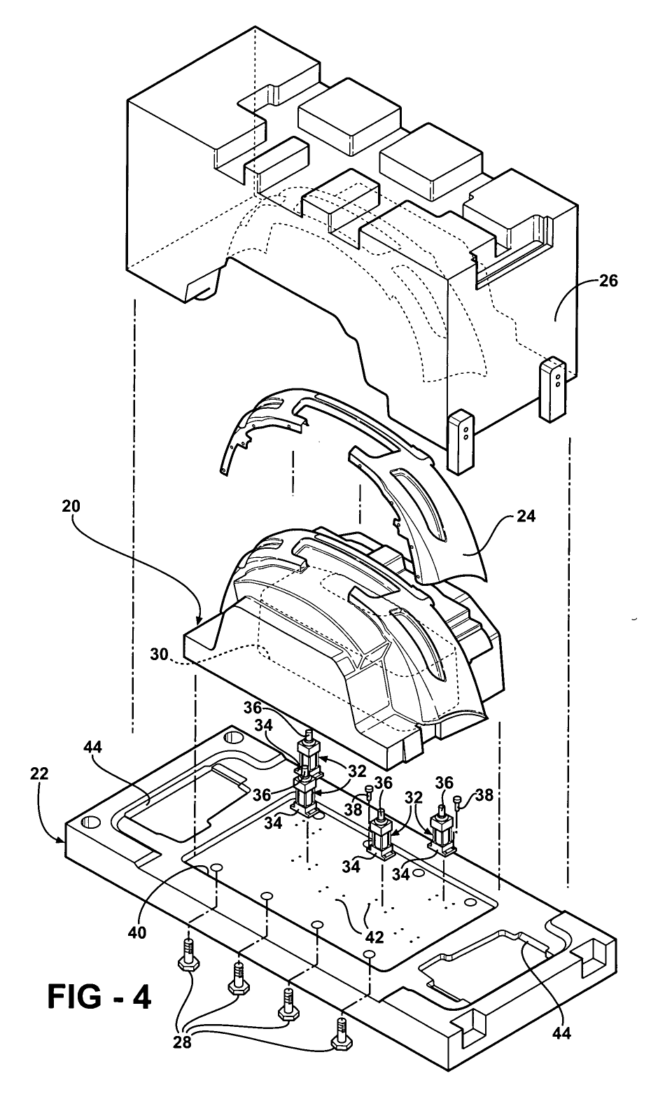

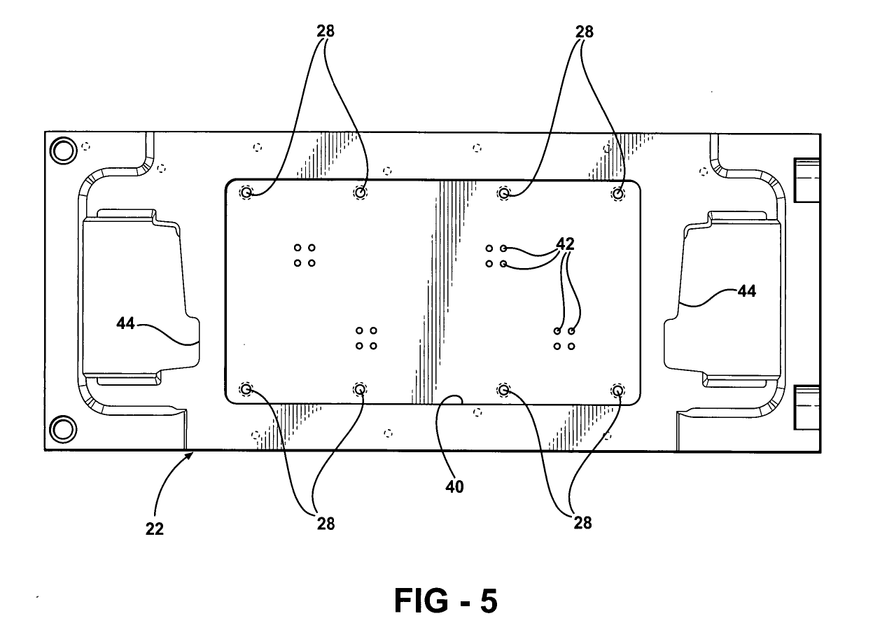

The base 22 also includes a slide pocket 44 and a slide match 46 slidably supported in the slide pocket 44 for forming a section 48 of the part 24 in a closed position and movable in the slide pocket 44 to an open position to allow the of the part 24 to be removed from the mold 20. In other words, the slide match 46 is in the closed position when the part 24 is being formed and a section 48 of the part 24 is formed between the slide match 46 and the mold 20. Referring to FIG. 3, as the slide match 46 is opened the slide match 46 pulls the section 48 sideways away from the mold 20 thus allowing the section 48 to clear the mold 20 when the ejectors 32 eject the part 24 upwards. The slide match 46 may be actuated hydraulically or pneumatically as shown by the actuator 50 shown on the right of FIG. 3 or mechanically by the opening and closing of the machine as shown by the slide pin 52 on left of FIG. 3.

The mold 20 includes cooling passages 54 extending therethrough and including inlet and outlet connections 56 for connection 56 to a source of cooling fluid independently of the base 22. For the purpose of clarity, only one continuous cooling passage 54 is illustrated in FIG. 3 and it should be appreciated that any number of independent cooling passages 54 may be employed. It is important that the cooling fluid be conveyed from a source and directly through cooling passages 54 extending through the mold 20 independently of the base 22, i.e., without passing the cooling fluid through the base 22 as in the prior art during flow between the source and the mold 20. The ability to have cooling passages 54 exclusively in the mold 20 reduces time to manufacture the mold 20. Because the cooling lines do not pass through the base 22, the cooling lines are shorter and require fewer access passages to gain access required to machine the cooling passages 54. In addition, the existence of the chamber 30 reduces and simplifies the machining required to create the cooling passages 54. The existence of the chamber 30 provides improved access to the areas of the mold 20 that require cooling passages 54. In addition, the space that the chamber 30 occupies would have otherwise been occupied by material and creation of the cooling passages 54 and access passages would require machining through this material.

Accordingly, the invention also provides a method of operating a mold assembly for an injection molding machine comprising the steps of mounting a mold 20 presenting a shaping surface for forming a part 24 on a base 22 to prevent relative movement therebetween during the forming of the part 24 and characterized by immovably mounting a plurality of ejectors 32 on the base 22 to extend through the mold 20 for actuation independently of one another for ejecting the part 24 from the shaping surface.

More specifically, the method includes removing the mold 20 from the base 22, removing at least some of the ejectors 32 from the base 22, mounting at least one of the removed ejectors 32 on the base 22 in a different and new position to define a different configuration of ejectors 32 on the base 22, and mounting a second or different mold 20 on the base 22 to prevent relative movement therebetween with the ejectors 32 extending through the second mold 20.

The steps are further defined as immovably mounting a stationary portion 34 of each of the ejectors 32 on the base 22 and extending an actuatable portion 36 of each of the ejectors 32 through the mold 20 and ejecting the part 24 from the shaping surface by moving the actuatable portion 36 relative to the stationary portion 34 and the base 22. Yet a further definition includes removably attaching the stationary portion 34 of each ejector 32 to the base 22 independently of one another by extending threaded screws 38 through the stationary portion 34 of each ejector 32 and into threaded engagement with the base 22. Since each ejector 32 is independently attached to the base 22, which is in turn immovable relative the machine, the method includes the step of actuating each of the ejectors 32 independently of one another to move the actuatable portion 36 of each ejector 32 relative to the mold 20. As alluded to above, the method includes forming a multiplicity of threaded holes 42 in the base 22 for mounting the ejectors 32 in a variety of configurations.

The steps are further defined by immovably attaching the mold 20 to the base 22 by extending a plurality of bolts 28 through the base 22 and threadedly engaging the mold 20.

At the end of the molding steps, a further step includes moving a slide match 46 to a closed position and forming a section 48 of the part 24 against the slide match 46 in the closed position and moving the slide match 46 to an open position and removing the part 24 from the mold 20.

Obviously, many modifications and variations of the present invention are possible in light of the above teachings. The invention may be practiced otherwise than as specifically described within the scope of the appended claims, wherein that which is prior art is antecedent to the novelty set forth in the “characterized by” clause. The novelty is meant to be particularly and distinctly recited in the “characterized by” clause whereas the antecedent recitations merely set forth the old and well-known combination in which the invention resides. These antecedent recitations should be interpreted to cover any combination in which the incentive novelty exercises its utility. In addition, the reference numerals in the claims are merely for convenience and are not to be read in any way as limiting.

### Element List

| Element Symbol | Element Name |
|---|---|
| 20 | mold |
| 22 | base |
| 24 | part |
| 26 | upper half |
| 28 | bolts |
| 30 | chamber |
| 32 | ejectors |
| 34 | stationary portion |
| 36 | actuatable portion |
| 38 | threaded screws |
| 40 | recess |
| 42 | threaded holes |
| 44 | slide pocket |
| 46 | slide match |
| 48 | section |
| 50 | actuator |
| 52 | slide pin |
| 54 | cooling passages |
| 56 | connections |

1. A mold (20) assembly for an injection molding machine comprising;
a base (22) for disposition in a molding machine,
a mold (20) presenting a shaping surface for forming a part (24),
a mounting system for mounting said mold (20) on said base (22) to prevent relative movement therebetween during the forming of the part (24), and
characterized by said mold (20) defining a chamber (30) with said base (22) and a plurality of ejectors (32) immovably mounted on said base (22) in said chamber (30) and extending through said mold (20) and independently actuatable for ejecting the part (24) from said shaping surface.

2. An assembly as set forth in claim 1 wherein each of said ejectors (32) includes a stationary portion (34) immovably mounted on said base (22) and an actuatable portion (36) extending through said mold (20) and movable relative to said stationary portion (34) and said base (22) for ejecting the part (24) from said shaping surface.

3. An assembly as set forth in claim 2 wherein said ejectors (32) include fastening devices for removably attaching said stationary portion (34) of each ejector (32) to said base (22) independently of one another.

4. An assembly as set forth in claim 3 wherein said fastening devices comprise threaded screws (38) extending through said stationary portion (34) of each ejector (32) and into threaded engagement with said base (22).

5. An assembly as set forth in claim 4 wherein said base (22) presents a multiplicity of threaded holes (42) for mounting said ejectors (32) in a variety of configurations.

6. An assembly as set forth in claim 3 including a controller for actuating each of said ejectors (32) to move said actuatable portion (36) of each ejector (32).

7. An assembly as set forth in claim 3 wherein said mounting system includes a plurality of bolts (28) extending through said base (22) and threadedly engaging said mold (20) to immovably attach said mold (20) to said base (22).

8. An assembly as set forth in claim 3 wherein said mold (20) includes cooling passages (54) extending therethrough and including connections (56) for connection (56) to a source of cooling fluid independently of said base (22).

9. An assembly as set forth in claim 3 wherein said base (22) presents a recess (40) presenting a periphery and said mold (20) interfaces with said periphery of said recess (40) in said base (22).

10. An assembly as set forth in claim 9 wherein said ejectors (32) are disposed in said recess (40).

11. An assembly as set forth in claim 3 wherein said base (22) includes a slide pocket (44) and a slide match (46) slidably supported in said slide pocket (44) for forming a section (48) of the part (24) in a closed position and movable in said slide pocket (44) to an open position to allow the section (48) of the part (24) to be removed from the mold (20).

12. A method of operating a mold (20) assembly for an injection molding machine comprising the steps of;
mounting a mold (20) presenting a shaping surface for forming a part (24) on a base (22) to prevent relative movement therebetween during the forming of the part (24), and
characterized by immovably mounting a plurality of ejectors (32) on the base (22) to extend through the mold (20) for actuation independently of one another for ejecting the part (24) from the shaping surface.

13. A method as set forth in claim 12 including removing the mold (20) from the base (22), removing at least some of the ejectors (32) from the base (22), mounting at least one of the removed ejectors (32) on the base (22) in a different and new position to define a different configuration of ejectors (32) on the base (22), and mounting a second mold (20) on the base (22) to prevent relative movement therebetween with the ejectors (32) extending through the mold (20).

14. A method as set forth in claim 13 including immovably mounting a stationary portion (34) of each of the ejectors (32) on the base (22) and extending an actuatable portion (36) of each of the ejectors (32) through the mold (20) and ejecting the part (24) from the shaping surface by moving the actuatable portion (36) relative to the stationary portion (34) and the base (22).

15. A method as set forth in claim 14 including removably attaching the stationary portion (34) of each ejector (32) to the base (22) independently of one another with fastening devices.

16. A method as set forth in claim 14 including removably attaching the stationary portion (34) of each ejector (32) to the base (22) independently of one another by extending threaded screws (38) through the stationary portion (34) of each ejector (32) and into threaded engagement with the base (22).

17. A method as set forth in claim 16 forming a multiplicity of threaded holes (42) in the base (22) for mounting the ejectors (32) in a variety of configurations.

18. A method as set forth in claim 14 including actuating each of the ejectors (32) independently of one another to move the actuatable portion (36) of each ejector (32) relative to the mold (20).

19. A method as set forth in claim 14 including extending a plurality of bolts (28) through the base (22) and threadedly engaging the mold (20) to immovably attach the mold (20) to the base (22).

20. A method as set forth in claim 14 including conveying cooling fluid from a source and directly through cooling passages (54) extending through the mold (20) independently of the base (22).

21. A method as set forth in claim 14 including moving a slide match (46) to a closed position and forming a section (48) of the part (24) against the slide match (46) in the closed position and moving said slide match (46) to an open position and removing the part (24) from the mold (20).
